(19) United States
(12) Patent Application Publication
(10) Pub. No.: US 2006/0015649 A1
(43) Pub. Date: Jan. 19, 2006

(54) Systems and methods for managing, creating, modifying, and distributing media content

(76) Inventors: Brad Zutaut, Studio City, CA (US); Richard S. Fortenberry, Cartersville, GA (US); Jonathan N. Schreiber, Beverly Hills, CA (US); Erik Kollner, Leiden (NL); Hal Bringman, Los Angeles, CA (US); Phil McGovern, Los Angeles, CA (US)

Correspondence Address: FISH & RICHARDSON, PC, P.O. BOX 1022, MINNEAPOLIS, MN, 55440-1022, US

(21) Appl. No.: 11/003,748

(22) Filed: Dec. 3, 2004

Related U.S. Application Data
(60) Provisional application No. 60/569,372, filed on May 6, 2004.

(51) Int. Cl. G06F 15/16

(52) U.S. Cl. 709/246; 709/219

(57) ABSTRACT

Disclosed is a system for managing, creating, modifying, and distributing media content. The system permits a user to customize and distribute the media content over a network from a first network device, such as a personal computer, to a second network device, such as a mobile phone. Prior to distributing the media content, the user can use the first network device to easily and automatically convert the media content from a first format to a second format that is recognizable and usable by the mobile device. Using the disclosed system, a user can easily and quickly access a media file and convert the entire file, or a portion thereof, to the second format.

### REFERENCE TO PRIORITY DOCUMENT

This application claims priority of co-pending U.S. Provisional Patent Application Ser. No. 60/569,372, entitled “System for Managing, Creating, Modifying and Distributing Media Content”, filed May 6, 2004. Priority of the aforementioned filing date is hereby claimed, and the disclosure of the Provisional Patent Application is hereby incorporated by reference in its entirety.

### BACKGROUND

The present disclosure relates to mobile communications and, in particular, relates to systems and methods for transferring media files to a mobile communication device.

In view of the explosive growth in the use of wireless telecommunication devices, users increasingly desire to transfer data files to their devices, such as to personalize the operation of the devices. One example is in the area of mobile telephones, where users are personalizing their phones by loading media files, such as graphic and sound files onto their phones.

For example, there is a growing trend for mobile phone users to use personalized ringtones when they receive a phone call rather than the default ringtone that is equipped on the phone. However, the process for loading a ringtone onto a user's phone can be tedious and expensive. Typically, the user will go through his or her mobile phone service provider to obtain new ringtones. Consequently, the user is limited to the particular ringtones offered by the mobile service provider. In addition, the user must typically pay a monthly service fee in addition to a download fee for each ringtone in order to obtain ringtones from the mobile service provider.

### SUMMARY

In view of the foregoing, there is a need for improved methods and systems for accessing, modifying, and distributing media content to wireless mobile devices. Disclosed is a method of distributing media content from a first network device to a second network device. The method comprises: accessing media content in a first media format; obtaining configuration information regarding the second network device, at least a portion of the configuration information descriptive of at least one media format compatible with the second network device; identifying a second media format compatible with the second network device; converting the media content from the first media format to the second media format to form a converted media content; instructing a third network device to send a message to the second network device, the message configured to cause the second network device to establish a communication link with the first network device; and, upon establishment of the communication link between the first and second network devices, transferring the converted media content in the second format to the second network device.

Further disclosed is a computer program on computer readable medium comprising instructions to cause a computer to: access media content in a first media format; obtain configuration information regarding the second network device, at least a portion of the configuration information descriptive of at least one media format compatible with the second network device; identify a second media format compatible with the second network device; convert the media content from the first media format to the second media format to form a converted media content; instruct a third network device to send a message to the second network device, the message configured to cause the second network device to establish a communication link with the first network device; and, upon establishment of the communication link between the first and second network devices, transfer the converted media content in the second format to the second network device.

Further disclosed is an information processing system comprised of an information processor configured to execute program instructions that cause the information processing system to implement one or more processes for distributing media content from a first network device to a second network device. The processes comprise: accessing media content in a first media format; obtaining configuration information regarding the second network device, at least a portion of the configuration information descriptive of at least one media format compatible with the second network device; identifying a second media format compatible with the second network device; converting the media content from the first media format to the second media format to form a converted media content; instructing a third network device to send a message to the second network device, the message configured to cause the second network device to establish a communication link with the first network device; and, upon establishment of the communication link between the first and second network devices, transferring the converted media content in the second format to the second network device.

The details of one or more embodiments are set forth in the accompanying drawings and the description below. Other features and advantages will be apparent from the description and drawings, and from the claims.

### DESCRIPTION OF DRAWINGS

FIG. 1 shows an exemplary system for managing, creating, modifying, and distributing media content.

FIG. 2 is a flow diagram that illustrates an exemplary method for managing, creating, modifying, and distributing media content.

FIG. 3 is a flow diagram that illustrates an exemplary method for configuring an application that is used to perform the method of managing, creating, modifying, and distributing media content.

FIG. 4 is an exemplary user interface window for configuring the application.

FIG. 5 is a flow diagram that illustrates an exemplary method for accessing, modifying, and converting media content.

FIG. 6 shows an exemplary user interface window for accessing, modifying, and converting media content.

FIG. 7 is a flow diagram that illustrates an exemplary method for transferring converted media content from a computer to a mobile device.

FIG. 8 shows an exemplary user interface that can be used to create and publish an online distribution site for converted media files.

FIG. 9 shows an exemplary user interface that permits a user to define the general configuration of the online distribution site.

FIG. 10 shows an exemplary user interface that permits a user to define the file management configuration of the online distribution site.

Like reference symbols in the various drawings indicate like elements.

### DETAILED DESCRIPTION

Disclosed is a system for managing, creating, modifying, and distributing media content. As used herein, the term “media content” includes any audio content, visual content, or any combination thereof in an electronic format. The system permits a user to customize and distribute the media content over a network from a first network device, such as a personal computer, to a second network device, such as any type of mobile device, including, for example, a mobile phone, a personal digital assistant, a personal computer, or combination thereof. Prior to distributing the media content, the user can use the first network device to easily and automatically convert the media content from a first format to a second format that is recognizable and usable by the mobile device. A “mobile device” includes any type of wired or wireless device that can interact with a computer network, such as, for example, a cell phone, a personal digital assistant, a handheld media player, personal computer, etc.

Using the disclosed system, a user can easily and quickly access a media file and convert the entire file, or a portion thereof, to the second format. The media file can comprise, for example, an electronic file that can be accessed by a mobile phone to generate ringtones. In one embodiment, the system operates by establishing a bi-directional communication link between a first device, such as a personal computer, and the mobile device, which permits the user to control the functionality of the first device using the mobile device, and vice-versa.

The second format can be in a different format than the first format or it can be in the same format as the first format. For example, the first format can be a 160 KBPS MP3 file that is converted to a 64 KBPS MP3 file. In another example, the first format and the second format are exactly the same format, although the media file has undergone some type of change during the conversion, such as to trim or otherwise edit the media file. Alternately, the media file is simply transferred to the mobile device without having undergone any change.

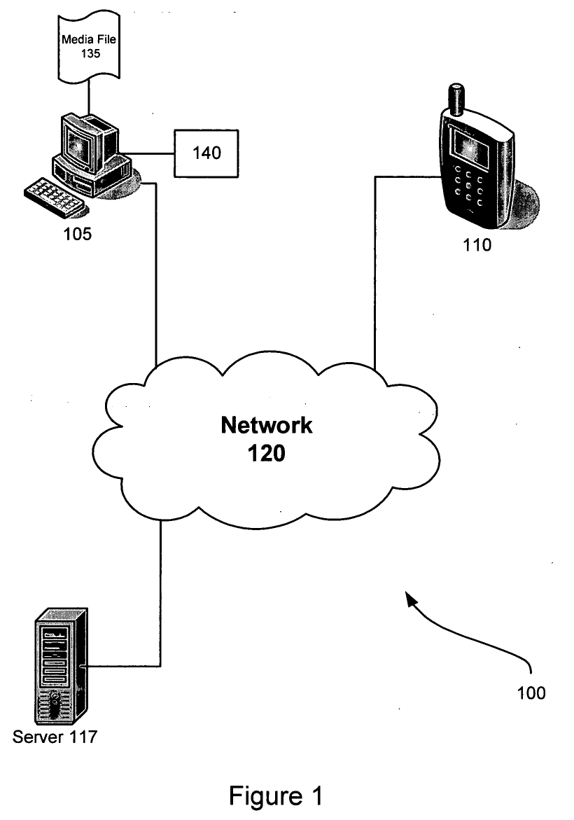

FIG. 1 shows a top-level, schematic diagram of a system 100 for managing, creating, modifying, and distributing media content. The system 100 includes a first node comprised of a first network device, such as a computer 105, and a second node comprised of a second network device comprising a mobile device 110. The computer 105 and the mobile device 110 are communicatively linked to a data access network 120, such as the Internet. A server 117 (sometimes referred to herein as the xingtone server) can also be communicatively linked to the data access network 120. The computer 105, mobile device 110, and server 117 are communicatively linked to one another via the data access network 120. The computer 105, mobile device 110, and server 117 can also communicatively couple to one another in other manners, such as, for example, via a wireless Bluetooth connection. It should be appreciated that the server 117 need not be used in some embodiments.

The computer 105 may be, for example, a PC having an operating system, such as, for example, a Microsoft Windows operating system. The computer 105 can include an output device, such as a monitor, and an input device, such as keyboard and/or pointing device, such as a mouse. Although the first network device is described herein in the context of being a computer, it should be appreciated that the network device can be any type of device configured to communicate with the data access network 120 and/or the mobile device 110. For example, the computer 105 and the mobile device 110 can be an Internet appliance or an appropriately Internet-enabled device such as a portable digital assistant (PDA). The particular type of device of the first network device is not limited so long as the network device can provide some measure of user interactivity with the data access network 120 and/or the mobile device 110.

The data access network 120 provides lower layer network support for the computer 105 to interact with the mobile device 110. The data access network 120 can comprise, for example, a common or private bidirectional telecommunications network (e.g., a public switched telephone network (PSTN), cellular network, a cable-based telecommunication network, a LAN, a WAN, a wireless network, or combinations thereof), coupled with or overlayed by a TCP/IP network (e.g., the Internet or an intranet). The computer 105 can communicate with the data access network 120 via a wired or a wireless connection.

The mobile device 110 primarily communicates with the data access network 120 via a wireless connection. In this regard, the mobile device 110 can connect to the network by connecting to a base station and mobile switching station of a wireless phone service provider of the mobile device 110. The network device 110 can also be configured to communicate via a wired connection with the data access network 120. In one embodiment, the computer 105, the mobile device 110, and the server 117 can directly communicate with one another without going through the data access network 120, either through a wired or wireless connection. Intercommunication between the computer 105, the server 117, the mobile device 110, and the data access network 120 can be configured pursuant to any of a wide variety of protocols and devices, such as, for example, a direct cable link, an infrared link, a Bluetooth link, a wi-fi link, a serial link, a firewire link, Over-the-Air (OTA), Short Messaging Service (SMS), Wireless Access Protocol (WAP), Bluetooth, etc., or any combination thereof.

With reference still to FIG. 1, the computer 105 has access to a media file 135. The media file comprises one or more electronic files that contain data representative of media content that a user can access, modify, and convert from a first format to a second, disparate format suitable for use on the mobile device 110. A media file that has been converted to the second format is referred to herein as the “converted media file”. As mentioned, the media content can be any audio and/or visual content in an electronic format. As described more fully below, the computer 105 has access to the media file 135, but the media file 135 does not necessarily reside on the computer 105.

A software application 140 resides in memory of or is otherwise coupled to the computer 105, the server 117, and/or the mobile device 110. The software application 140 is configured to interact with the computer 105, the server 117, and/or the mobile device 110 to effect the operations described herein. In one embodiment, the software application 140 is a terminate and stay resident (TSR) application that remains in computer memory once loaded in order to be quickly accessible. In another embodiment, the application 140 is a plug-in application that integrates with a browser and/or operating system on the computer 105. In another embodiment, the software application 140 resides on the mobile device 110 and the mobile device performs all of the operations described herein. For example, the media file is accessed by the mobile device 110 and the mobile device 110 performs the playing, viewing, trimming, and conversion of the media file, as described below. In yet another embodiment, the computer 105 and the mobile device 110 both perform some or all of the operations described herein such that the processing is shared by both the computer 105 and the mobile device 110.

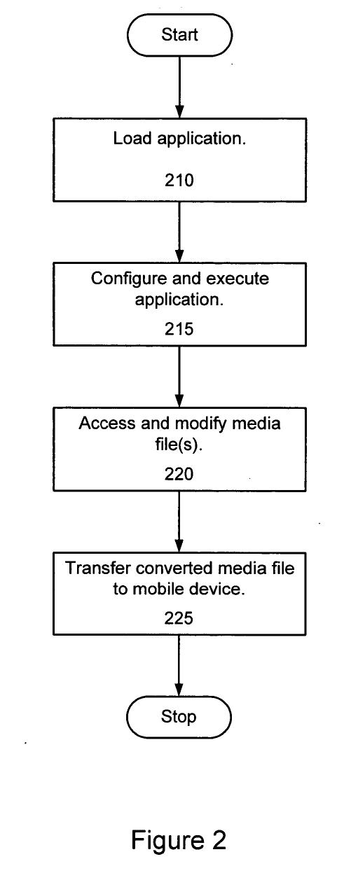

With reference to FIG. 2, there is now described an exemplary method for accessing, managing, creating, modifying, and distributing media content. In the exemplary embodiment, the media file is initially accessed and modified using the computer 105 and is distributed to the mobile device 110. However, it should be appreciated that the method of FIG. 2 can be performed by the mobile device 110, the server 117, or combinations thereof. Furthermore, the operations can be performed in an ActiveX control environment such that the operations are executed through a browser and the processing is performed on the computer 105 and/or the server 117.

In a first operation, represented by flow diagram box 210 in FIG. 2, the application 140 is initially loaded onto the computer 105. The loading or installation can be accomplished in a variety of manners, such as by loading the application 140 using a floppy disk or CD-ROM or by downloading the application from the data access network 120 (such as via the Internet). In another embodiment, the application 140 comprises a Java applet or the like. As mentioned, in other embodiments, the application 140 can be loaded onto the mobile device 110 or onto both the mobile device 110 and the computer 105, as well as onto the server 117.

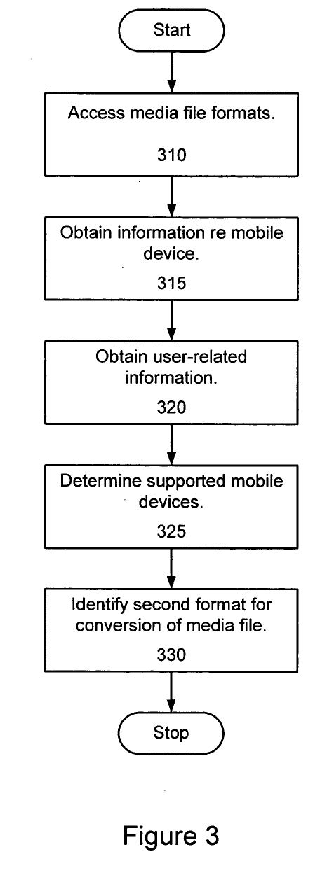

In a next operation, represented by flow diagram box 215, the application 140 is executed and configured for operation. An exemplary method for configuring the application 140 is described in detail below with reference to the flow diagram of FIG. 3. When the application 140 is executed, the application 140 can cause a visual representation of the media file to be displayed on the computer 105, such as within a window that opens on the monitor of the computer 105, as described in more detail below.

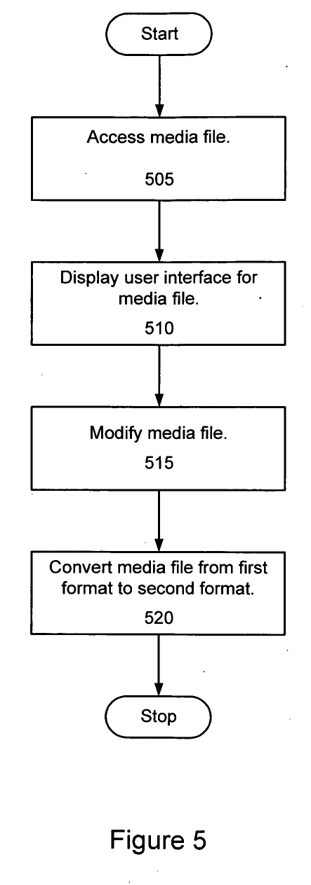

In the next operation, represented by the flow diagram box 220, the application 140 accesses and modifies one or more media files associated with the media content. The operation of flow diagram box 220 includes the process of converting the media file from a first format to a second, disparate format that is usable by the mobile device 110. An exemplary method for accessing and modifying the media file is described below with reference to the flow diagram of FIG. 5.

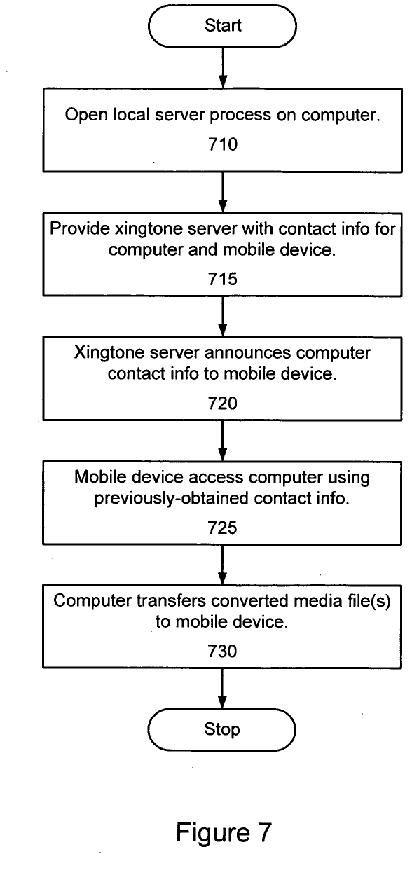

In the next operation, represented by the flow diagram box 225, the application 140 transfers the converted media file from the computer 105 to the mobile device 110. An exemplary method for transferring the media file is described below with reference to the flow diagram of FIG. 7. The method is then complete. It should be appreciated that various portions of the method of FIG. 2 can be performed by the computer 105, the mobile device 1 10, and the server 117 and that the processing can be shared between the various devices.

Initial Configuration of the Application

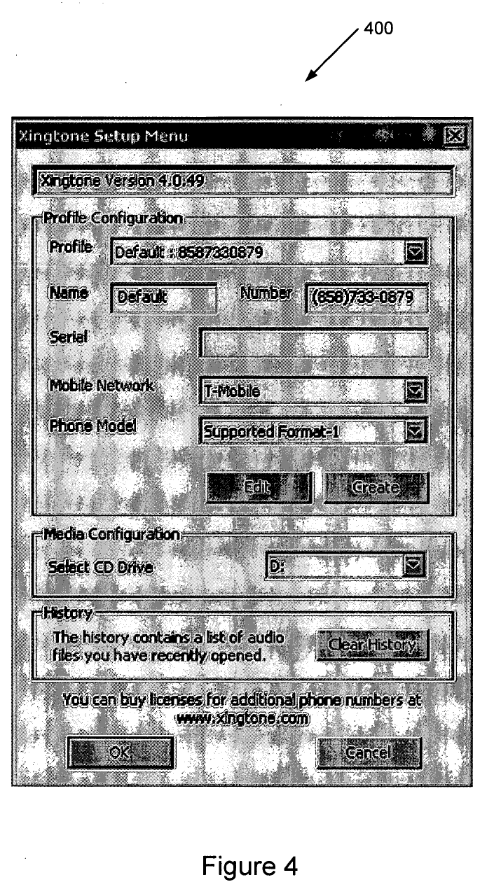

FIG. 3 shows a flow diagram that describes an exemplary method of configuring the application 140 for use in modifying, converting, and distributing the media file 135. Pursuant to the configuration process, the application 140 obtains information that is used to convert the media file 135 from the first format to the second format and to distribute the converted file to the mobile device 110. As mentioned, the initial configuration process occurs after the application 140 has been installed on the computer 105. It should be appreciated that the operations of the flow diagram of FIG. 3 need not be performed in the order shown in the flow diagram, but can rather be performed in any order. It should further be appreciated that the user can accomplish the configuration process in a variety of manners. For example, the user can interact with a user interface window that is generated by the application 140. FIG. 4 shows an exemplary user interface window 400 that is displayed to the user during at least a portion of the configuration process.

With reference again to FIG. 3, in a first operation, represented by flow diagram box 310, the application 140 accesses information regarding media file formats that are supported by the operating system (OS) on the computer 105. For example, the application 140 connects to the OS media layer to access installed media file formats for playback and conversion. Some exemplary formats are Microsoft (MS) Directshow Services for Windows, media audio and raw wav formats, QuickTime, etc, or any installed media services platform for the purpose of utilizing their installed codecs and rendering functionality. It should be appreciated that any format for displaying or utilizing media content can be used. The application 140 can also include its own media applications so that it would not need to rely on media applications that independently reside on the computer 105.

In the next operation, represented by flow diagram box 315, the application 140 obtains information regarding the mobile device 110, wherein the information can be used to facilitate conversion of the media file from the first format to the second format and to transfer the converted file to the mobile device 110. In the context of the mobile device 110 being a mobile telephone, the application obtains, for example, the mobile telephone number of the device, the make and model of the device, and the mobile service provider (the carrier). Such information essentially provides the application 140 with “contact information” for the mobile device 110 as well as information regarding the general configuration of the mobile device 110.

In the context of the mobile device 110 being a mobile phone, the application 140 can permit the user to identify the mobile phone and service provider from a predetermined group of cell phone types and service providers. For example, the application UI can display one or more drop-down menus that include a list of user-selectable cell phone types and service providers. As described below, the application 140 has access to data that describes formats that are usable by those cell phone types and service providers. Using such data, the application 140 can automatically select the second format based on the user's identification of the cell phone and service providers (including mobile gateway specifications, document formatting and any carrier specific protocol restrictions).

In one embodiment, the application 140 limits the user to providing information for only a single mobile device 110 such that the computer 105 can only transfer the converted media file to that single mobile device. This will limit a user from distributing multiple copies of the converted media file to multiple mobile devices (and hence multiple users), such as to facilitate compliance with copyright ownership laws. In other embodiments, the application 140 permits the user to provide information for a plurality of mobile devices to which the converted media content can be transferred. For security reasons, the application 140 may require that the user enter a serial number provided by an application vendor.

In the next operation, represented by flow diagram box 320 in FIG. 3, the application 140 obtains user-related information. The user-related information can include contact information for the user, such as name, address, telephone number, etc. The user-related information can also include demographic information, such as age, gender, interests, etc. The application 140 can use the user-related information to display advertisements within one or more advertisement panes located on subsequent user interface windows. The advertisements can also be displayed in any other manners, such as via instant messaging or the like. The advertisements can be selected based on the user demographics. In this regard, the application can connect to the server 117 (shown in FIG. 1) to retrieve a document (such as an HTML formatted document) that is displayed in the advertisement pane based on defined user, demographic, etc, criteria. The document for display in the advertisement pane can also be selected using intelligent collaborative filtering. The document for display can also be randomly selected or selected based on any other criteria.

In another operation, the application 140 determines whether the user-specified mobile device(s) are supported, as represented by the flow diagram box 325 in FIG. 3. Codecs can be included in the application 140 to cause the application 140 to connect to an informational document, such as a Web-based XML document housed on the server 117. The XML document can contain specifications for phone model types, mobile content conversion format types and mobile carrier specific information (mail gateway, etc).

The application 140 then utilizes the web based XML documents for current conversion methods, file formats, image formats, schemes and supported handsets, devices and other media file format information. In this regard, the application 140 can obtain access to a data link library (DLL) that contains information necessary for converting the media file from the first format to the second format supported by the particular mobile device. This allows for real time, accurate conversion to appropriate file formats. In other words, the application 140 obtains information regarding the second format to which the media file will be converted such that the media file can be used on the mobile device 110.

In the next operation, represented by flow diagram box 330 in FIG. 3, the second format to which the media file is converted is identified. In one embodiment, the user is not required to identify to the application 140 the second format to which the media content will be converted. Rather, the application 140, in combination with the server 117, automatically obtains the second format information, such as by obtaining one or more DLLs associated with the mobile phone type and carrier. In this manner, the conversion process is automatic and transparent to the user.

Alternately, the user can manually select the second format. For example, the application 140 can present the user with a list of possible second formats to which the media file will be converted based on specifications defined by the mobile handset manufacturer for the mobile device 110. The user may have choices based on the mobile device 110 being compatible with multiple file formats regardless of the service provider and cell phone type. This enables the user to select the second format based on the particular properties of the mobile device 110 and also based on any properties of the data access service provider for the mobile device 110. If desired, the user can also be allowed to arbitrarily pick the second format.

In yet another embodiment, the application 140 communicates with the mobile device 110 and obtains identification information from the mobile device, including the type(s) of formats of media content that are usable by the mobile device 110. The application 140 then automatically selects the second format without requiring user interaction. Thus, as described above, the selection process is automatic and transparent to the user in that the user is not required to select the model of the mobile device or the service provider of the mobile device.

In one embodiment, after the initial configuration, the second format is fixed once selected and cannot be changed. The application 140 will then always convert the media file to the initially-selected second format. In another embodiment, the user can manually select the second format every time a conversion is performed so that the user can select the second format at the time of each conversion. This will permit the user to arbitrarily vary the second format to which the media file is converted.

The initial configuration process is then complete. Upon completion of the process, the application 140 has obtained the information for converting the media file from the first format to a second format suitable for use on the mobile device 110 and for transferring the converted file to the mobile device 110.

Access. Modification, and Conversion of the Media File

As discussed above, pursuant to the flow diagram box 220 of the flow diagram of FIG. 2, the application 140 is used to access, modify, and convert the media file from a first format to a second format suitable for use by the mobile device. The second format was identified during the configuration process described above. An exemplary method for accessing, modifying, and converting the media file is now described in more detail with reference to the flow diagram of FIG. 5.

In the first operation, represented by the flow diagram box 505 in FIG. 5, the application 140 accesses the media file 135. As mentioned, the media file 135 can be, for example, a graphics file that contains data relating to an image. The media file 135 can also be an audio file that contains audio data, such as a musical tune. The process is described herein in the context of the media file 135 being an audio file, although it should be appreciated that the media file can be any type of media file, such as an image or video file.

In one embodiment, the computer 105 accesses the media file 135 from a local memory store, such as a local hard drive. The media file 135 can reside on removable media, such as a CD or DVD that is accessed from an appropriate drive coupled to the computer 105. In another embodiment, the computer 105 accesses the media file 135 from a remote location, such as from a remote node on the data access network 120 pursuant to a file sharing scheme. In yet another embodiment, the user creates the media file 135 from scratch rather than accessing an already-existing file. For example, the computer 105, via the application 140, can interface with a MIC or audio capture process to create an audio file. In the context of an image file, the user can create an image file using any well-known application.

When initially accessed, the media file 135 is in the first format. Some exemplary format types of media files are listed below. It should be appreciated that the system 100 is not limited to use with the following types of media content and that the system 100 can be configured to work with any type of media content.
Uncompressed WAV PCM;
Compressed WAV (GSM, ADPCM, DSP and others);
MP3 (MPEG 1/2 Layer 3, including VBR);
MP2 (MPEG 1/2 Layer 2);
VOX (Dialogic ADPCM);
RAW audio (PCM, A-Law, U-Law);
WMA (Windows Media Audio);
AVI (audio stream);
Ogg Vorbis (ver 1.0);
MPC (MusicPack);
G.726, G.723, G.721;
AIFF (Apple);
AU (UNIX).
Apple Quicktime
Real
MPEG1, 4
Streaming video (MPEG 4, etc.)
Web cam (animated gifs, streaming video codecs)
MP3, MP3 Pro
Proprietary formats, such as formats proprietary to Sony Corporation.
Voice codecs

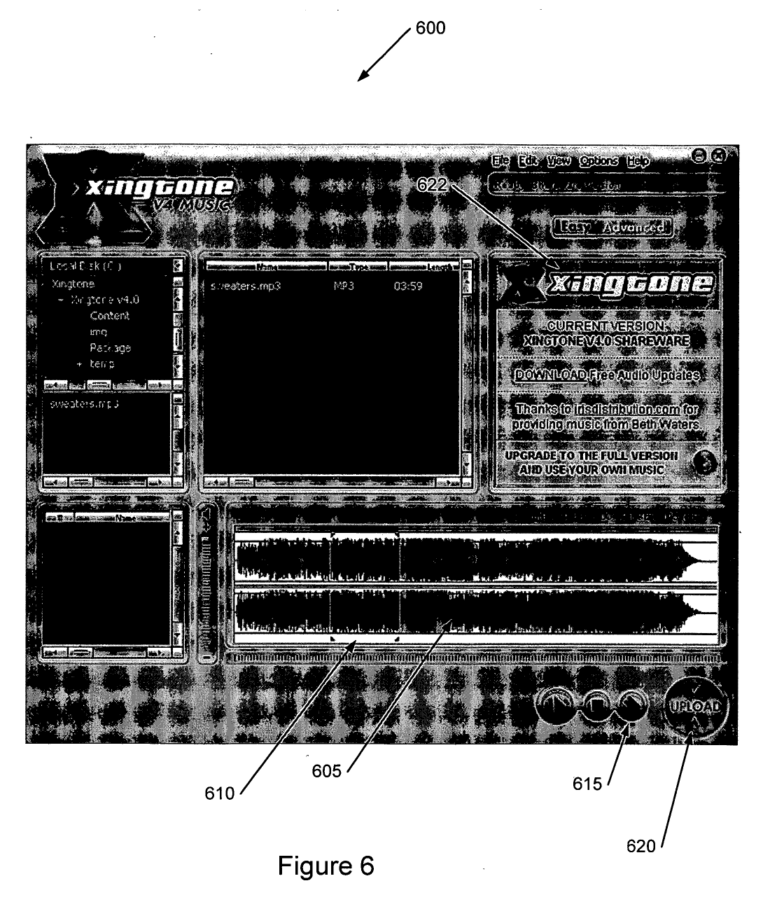

In the next operation, represented by the flow diagram box 510 in FIG. 5, the computer 105 generates a user interface (UI) on the display device 125 that permits the user to access the media file 135. In one embodiment, the UI permits the user to view a visual representation of the media file 135. FIG. 6 shows an exemplary UI window 600 that permits a user to view, modify, and convert the media file. The window 600 displays a visual representation of the media file, such as in the form of a wav form representation 605 in the case of an audio file. As mentioned, the window 600 can includes an advertisement pane 622 that can display one or more advertisements to the user. The advertisements can be downloaded from the server 117. It should be appreciated that the application 140 is not required to provide any audio or visual representation of the media file. For example, for audio files, the application 140 can simply play the audio file for the user. The application 140 can also automatically edit the media file based on parameters of the mobile device. For example, the application 140 can automatically truncate the media file to a size that is configured for use on the mobile device.

In the next operation, represented by flow diagram box 515, the user optionally modifies or edits the media file 135. The modification of the media file can vary widely. For example, in the case of the media file 135 being a graphics or video file, the user can clip, shade, lighten, or otherwise modify the appearance of the graphics or video file. In the case of the media file 135 being an audio file, the user can perform various edit functions on the media file. For example, the user can zoom-in and out on portions of the file, adjust the volume, perform a fade-in or fade-out, etc. The user also can clip or trim a portion of the audio file. In one embodiment, the user selects and identifies a portion of the media file 135 for clipping using a mouse, such as by clicking and dragging a mouse pointer around a selected portion of the wav form representation 605. The selected portion of the wav form is then “highlighted” on the user interface. For example, FIG. 6 shows a selected portion 610 of the wav form 605 highlighted in bolded format.

Once the portion of the waveform is selected for clipping, the user can cause the application 140 to “trim” the media file to include only the selected portion 610, such as by clicking on a trim button 615 on the user interface. Once the media file is trimmed, the application 140 causes the user interface to be redrawn to display only the selected portion of the media file minus the unselected portion. If the user edits the media file, the application 140 can save a new instance of the media file or can simply save the edited version of the media file by replacing the original media file.

After editing of the media file, the application 140 enables the user to convert the media file (either the original version or the edited version) from a first, original format to a second, disparate format that is usable by the mobile device 110. This operation is represented by flow diagram box 520 in FIG. 5. The first format is the format the media file is in when originally accessed by the computer 105. As discussed, the second format was previously determined during the configuration process. The particular second format can be fixed such that, once selected, the user cannot change the second format. In this case, the application 140 always converts the media file to the second format that was automatically or manually selected during the initial configuration. Alternately, the application 140 can be configured such that the second format can be selected at the time of the conversion process.

The user initiates the conversion process by interacting with the user interface window 600, such as by selecting a button on the user interface. The application 140 then transcodes (i.e., converts) the media file 135 to the second format. The application 140 can use one or more of the previously-obtained DLL files to perform the conversion of the media file 135 into the second format. As mentioned, the DLLs contain information regarding conversion methods, file formats, and image formats for the mobile device 110. The conversion information for the second format can also be hard-coded into the application 140.

The conversion of the media file 135 can occur at the computer 105, at the server 117, or at the mobile device 110, or combinations thereof. For example, the server 117 can include in memory a version of the media file 135, convert the media file 135, and then download the converted media file to the computer 105 or to the mobile device 110. Alternately, the computer 105 can perform the conversion and then transfer the converted media file to the mobile device 110. In this regard, the computer 105 can retain the media file or temporary versions of the media file in a location that is hidden from the user such that the user cannot access the media file once the application 140 is closed. Alternately, the application 140 can permit the user to save the converted media file at any location pursuant to the user's discretion.

In yet another embodiment, the application. 140 is configured to convert the original media file into a plurality of separate converted files. The separate converted files can each have a different format that is suitable for use in a different mobile device. The user can then post the converted media files in an online environment, such as on a Web page where the user can provide other users with access to the different versions of the media files, such as for a fee. In this manner, the application 140 is at least partially used to create an online store where converted versions of an original media file can be accessed by various other users. A process for creating an online access site is described in more detail below.

The application 140 can require the user to provide a name for the converted file or it can automatically assign its own name to the converted file. It should be appreciated that the application 140 can convert the media file 135 at any point in the process prior to transferring the converted media file to the mobile device 110. For example, the application 140 can convert the media file at the time the application 140 initially opens the media file, after the media file is trimmed, or at any point prior to transferring the converted media file to the mobile device or to the server 117.

The access, modification, and conversion process is now complete for the media file 135.

Transfer of the Converted Media File to the Mobile Device

As discussed above, pursuant to the flow diagram box 225 in the flow diagram of FIG. 2, the converted media file is next transferred to the mobile device, such as upon the user clicking on an “upload” button 620 located on the user interface window 600 (shown in FIG. 6). In one embodiment, the user can deliver the converted media file to any mobile device of the user's choosing and can change at will the mobile device to which the file will be delivered. In another embodiment, the application 140 limits delivery to a single mobile device, which mobile device was identified by the user during the previously-performed configuration process.

A direct, bidirectional communication link can be established between the computer 105 and the mobile device 110. Pursuant to this communication link, the user can access the computer 105 via the mobile device 110 and vice versa. For example, the user can remotely interact with the computer 105 using the mobile device 110, such as to access and control a live image from a webcam coupled to the computer 105.

There are various methods for transferring the converted media file between the computer 105 and the mobile device 110. One exemplary method is referred to as a “content stream-through” method. The content stream-through method can be employed for user environments where strict firewall\proxy rules are required or recommended. This method minimizes user configuration of blocked ports and proxy forwards due to security settings and proxy configuration where security is emphasized and network control is required. The content stream-through method allows for greater user configuration ease, although it uses pass through of the converted media file through the server 117. The content stream-through scenario can be implemented, for example, where content ownership and copyright restrictions are irrelevant as copies of the converted media file can reside at multiple locations in the network 120.

In one embodiment of the content stream-through method, the application 140 uses a standard windows socket and a predetermined web port (e.g., web port 80) to transfer the converted media file from the application 140 on the computer 105 to a server process at the server 117. The server 117 then re-directs the converted media file to the mobile device 110, such as via http controls. An exemplary benefit of the content stream-through method is that it requires little or no user configuration and works well in even strictly controlled network environments.

Another method for transferring the converted media file to the mobile device 110 is referred to herein as the “peer-to-peer” method. The peer-to-peer method can be used for usage environments where no server activity is required. The peer-to-peer method allows for true peer-to-peer type connectivity between the application 140 and the mobile device 110. Some user configuration can be required if the application 140 is running behind router\proxy.setup. However, once the configuration is defined, the application 140 simply transfers the converted media file to the mobile device 110 and no further interactivity between the application 140, server 117, and the mobile device 110 is required.

In order for the mobile device 110 (which can be routed) to find and achieve port connection with the application 140 (which can also be routed), one of the devices is manually set to forward a known port in order to make the connection. Because the mobile device 110 can be beyond the control of the application 140 configuration, this is achieved by manually (e.g., through software configuration) forwarding a defined port at the user-desktop PC level so that a fully qualified IP address\port combo is reachable via web\internet protocols. For any connected user and instance of the application not connected via a router\routable hub or any other proxy related configuration, the application 140 will behave as usual. The peer-to-peer method allows for true peer-to-peer type connectivity for routed devices. The peer-to-peer method completely removes the server 117 from any functional role in the media content transfer process.

Another transfer method is referred to as the “server-initiated” transfer method. The server-initiated transfer method can be used for user environments where copyright and content restrictions mandate user-defined control of the transport of the media content, which is assumed to be owned by the user. The server-initiated method can be used to allow the user to manage the transfer of the converted media file directly to the mobile device 110 from the computer 105 with minimal interaction by the server 117.

Pursuant to the server-initiated method, the server 117 acts as a directional facilitator between the computer 105 and the mobile device 110 in that the server 117 provides the computer 105 and/or the mobile device 110 with information for transferring the media file between the devices. The server does not necessarily obtain a copy of the media file or the converted media file during the transfer process. The server 117 delivers one or more messages (such as text messages) to the mobile device 110 and initiates a resulting transfer of the converted media content from the computer 105 to the mobile device 110. The server 117 then disengages from the process and allows the media file transfer to proceed between the computer 105 and the mobile device 110. In the server-initiated method, the media file or the converted media file is never stored, written to disk, or kept in memory of the server 117.

The server-initiated method for transferring the converted media file from the computer 105 to the mobile device 110 is now described in more detail with reference to the flow diagram of FIG. 7. The first operation is represented by the flow diagram box 710. In this operation, the computer 105 opens a local server process that enables the computer 105 to function, for example, as an HTTP server over the data network 120. The application 140 causes the computer 105 to open a socket to the server 117 and request, via the data access network 120, a connection with the server 117. If the server 117 is available, the server 117 acknowledges the request and a connection between the server 117 and the computer 105 is established.

In the next operation, represented by flow diagram box 715, the computer 105 provides contact information for both the computer 105 and the mobile device 110 to the server 117. The contact information for the computer 105 can include, for example, a unique data network address (e.g., an http or IP address) and a port number. The computer 105 can use dynamic and random ports in order to maximize port connections on the local server process, to minimize improper exploits of the local server process, and so as not to interfere with common web application ports on the computer 105. The computer contact information also includes an address associated with the location of the converted audio file. In the scenario where the mobile device 110 comprises a mobile phone, the contact information for the mobile device 110 can include, for example, the telephone number and wireless service provider for the mobile phone.

The next operation is represented by flow diagram box 720 in FIG. 7. In this operation, the server 117 provides at least a portion of the contact information for the computer 105 to the mobile device 110. The sever 117 can provide the information to the mobile device in a variety of manners. For example, the server 117 can send a message to the mobile device, such as a text message, a WAP push message, an SMS message, etc. The message can include contact information for the computer 105, such as the IP address of the computer 105 and the port number for the local server process running on the computer 105. During this operation, the server 117 can order the application 140 to standby and wait for a subsequent response from the mobile device 110. If the response is not received within a predetermined time span, the local server process on the computer 105 can terminate. At this stage in the process, the server 117 need not take any further involvement in the transfer of the converted media file to the mobile device 110.

In the next operation, represented by flow diagram box 725 in FIG. 7, the mobile device 110 connects to the computer using the previously-provided contact information contained in the message from the server 117. The message that was sent to the mobile device 110 can have an embedded link to a URL that, when accessed, causes the mobile device 110 to connect to the computer 105 and request the converted media file. The embedded URL in the delivered message is launched\opened in a web browser of the mobile device 110. When the embedded URL is opened by a user of the mobile device 110, a document (such as, for example, a WML, Xhtml, html, hdml, etc, document) containing the unique IP and port for the local server process on the computer 105 is displayed in the mobile browser, along with some type of identifier for the converted media file. It should be appreciated that the actual IP address for the computer 105 need not be displayed on the mobile device 110. Rather, the mobile browser can display some other type of identifier that the user of the mobile device can highlight and select. Moreover, the mobile device 110 can be configured to automatically connect to the computer 105 and request transfer of the converted media file such that the whole process is transparent to the user of the mobile device 110.

In the next operation, represented by flow diagram box 730 in FIG. 7, the local server on the computer 105 responds to the request of the mobile device 110 and transfers the converted media file to the mobile device 110. The transfer can occur via the data access network 120. The converted media content located the computer 105 is transferred over the data access network 120 using TCP\IP protocol directly from the computer 105 to the mobile device 110. At this point, the server 117 can send an advertisement document (such as an HTML document) to the application 140 for display in the advertisement pane 622 (FIG. 6) of the user interface window 600. The advertisement can be selected based on various criteria, such as, for example, a) whether the converted media file was successfully sent, in which case a message is displayed accordingly; or b) on the demographic of the user, or any other criteria.

In one embodiment, the application 140 deletes the media file and/or the converted media file from the computer 105 upon successful transport of the converted media file to the mobile device 110. Alternatively, a temporary media file can be stored and\or shared for additional or later use. It should be appreciated that various modes of transport are possible, such as, for example, Bluetooth, IR, Wi-fi, or cables to move the media file from the computer 105 to the mobile device 110.

In an alternate embodiment, the computer 105 transfers the converted media file to the server 117, where the server 117 stores the converted media file. The mobile device 110 can then initiate a connection with the server 117 and download the converted media file directly from the server 117. The transaction is complete and the application terminates connection.

Creation of Online Access Site

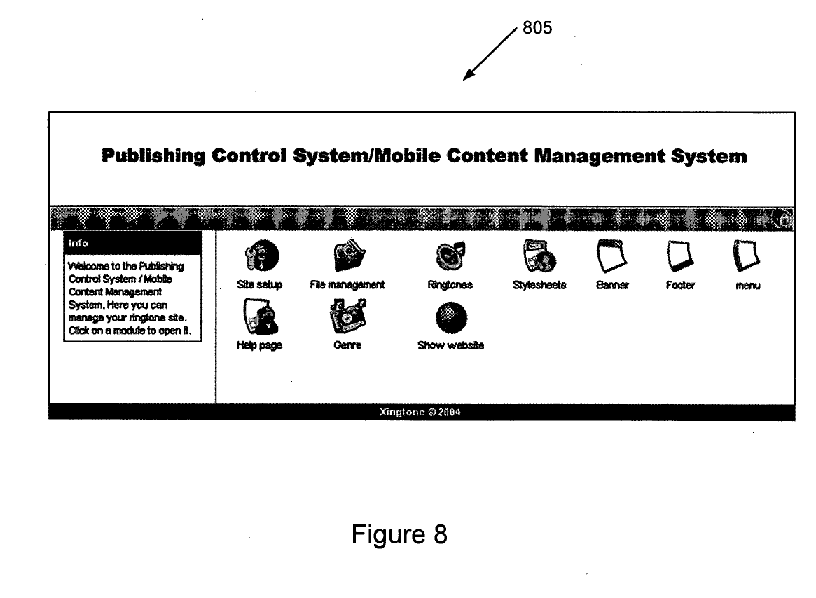

As discussed above, the application 140 can be used to create a plurality of converted media files that can be accessed by other users (such as for a fee) at an online store. There is now described a process for publishing such an online site. FIG. 8 shows an exemplary user interface 805 that can be used to publish an online distribution site for converted media files. The user interface includes user-selectable icons that can be accessed by a user to define the parameters and configuration of the resultant online distribution site.

With reference to FIG. 8, an exemplary embodiment of the user interface 805 includes ten icons, including a “File setup” icon, a “File management” icon, a “Ringtones” icon, a “Stylesheets” icon, a “Banner” icon, a “Footer” icon, a “Menu” icon, a “Help page” icon, a “Genre” icon, and a “Show Website” icon. It should be appreciated that the icons are exemplary and that the icons can be arranged differently. When a user selects one of the icons, a new page is rendered that permits a user to define the configuration of the online distribution site.

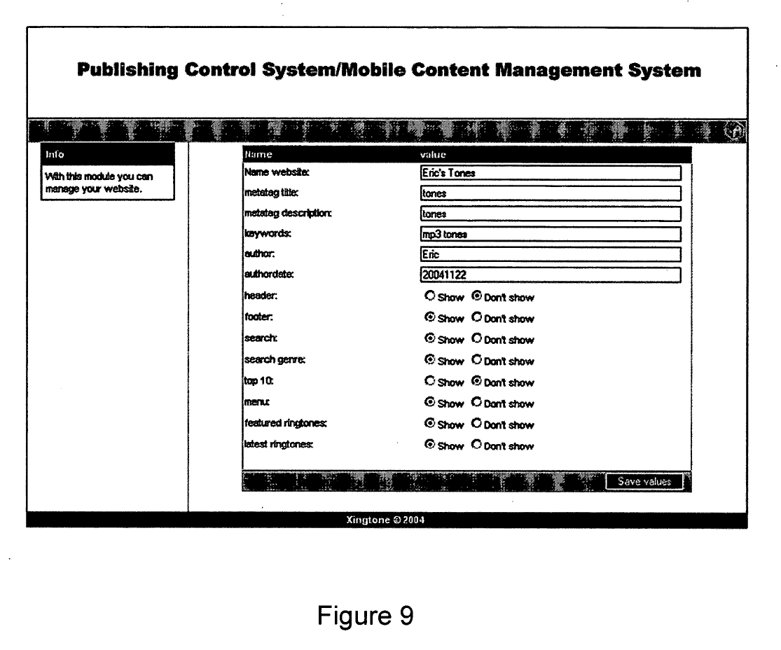

For example, selection of the “Site setup” icon leads to a page that permits the user to define the general configuration of the online distribution site, such as, for example, the name of the site, keywords associated with the site, whether a header or footer is displayed on the site, and other parameters. FIG. 9 shows an exemplary user interface that is generated when the “Site setup” icon is selected and that permits a user to define the general configuration of the online distribution site.

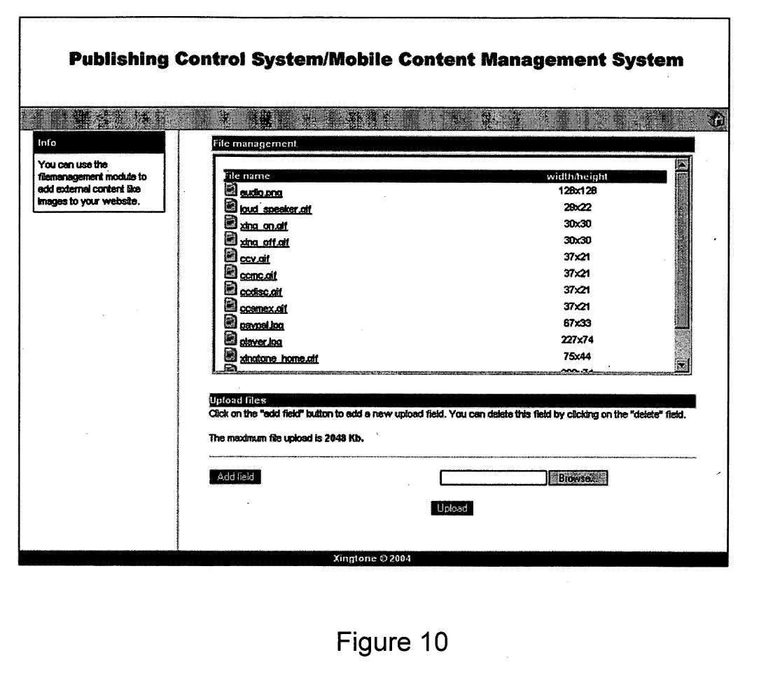

In another example, selection of the “File management” icon leads to a page that permits a user to define what type of content, such as images, are displayed on the distribution site. FIG. 10 shows an exemplary File Management page.

Other pages for further defining the configuration of the online distribution site can be accessed by selecting other icons. For example, if the online distribution site is used to distribute ringtones, the user can select the “Ringtones” icon to access a page that permits the user to identify and add one or more ringtone files to the online distribution site. The various other icons are selected to access other pages in which the user can further define the online distribution site. Once the user has defined the online distribution site, the user selects the “Show website” icon, which generates a Web page for the site.

A number of embodiments have been described. Nevertheless, it will be understood that various modifications may be made without departing from the spirit and scope of the claims. Accordingly, other embodiments are within the scope of the following claims.

What is claimed is:

1. A method of distributing media content from a first network device to a second network device, comprising:
accessing media content in a first media format;
obtaining configuration information regarding the second network device, at least a portion of the configuration information descriptive of at least one media format compatible with the second network device;
identifying a second media format compatible with the second network device;
converting the media content from the first media format to the second media format to form a converted media content;
instructing a third network device to send a message to the second network device, the message configured to cause the second network device to establish a communication link with the first network device;
upon establishment of the communication link between the first and second network devices, transferring the converted media content in the second format to the second network device.

2. A method as in claim 1, wherein the second network device comprises a mobile phone, and wherein the configuration information comprises a phone number, a make, a model, and a mobile service provider associated with the mobile phone.

3. A method as in claim 1, further comprising identifying a plurality of media formats compatible with the second network device, and wherein identifying a second media format compatible with the second network device comprises permitting a user to select the second media format from the plurality of media formats.

4. A method as in claim 1, further comprising automatically identifying the second media format without receiving feedback from a user.

5. A method as in claim 1, wherein the first network device comprises a personal computer, the second network device comprises a mobile phone, and the third network device comprises a server device.

6. A method as in claim 1, wherein the message to the second network device includes an embedded link that causes the second network device to establish the communication link with the first network device.

7. A method as in claim 6, wherein the embedded link includes a unique IP address and port for a local server process running on the first network device.

8. A method as in claim 1, further comprising obtaining media conversion data, the media conversion data comprising information for converting the media file from the first media format to the second media format.

9. A method as in claim 8, wherein the media conversion information is obtained from the third network device.

10. A method as in claim 1, wherein the message from the first network device to the second network device comprises a text message, a Wireless Access Protocol (WAP) message, or a Short Message Service (SMS) message.

11. A method as in claim 1, wherein the media content comprises an audio file.

12. A method as in claim 1, wherein the media content comprises a video or graphics file.

13. A method as defined in claim 1, further comprising displaying a visual representation of the media content.

14. A method as defined in claim 13, wherein the media content comprises an audio file, and wherein the visual representation comprises a wav form representation of the audio file.

15. A method as defined in claim 13, wherein the media content comprises a graphic file, and wherein the visual representation comprises a drawing of the graphic file.

16. A method as defined in claim 1, further comprising permitting a user to identify and select a portion of the media content for conversion to the second media format and for transferring to the second network device.

17. A method as defined in claim 1, wherein the second network device comprises a mobile phone and the media content comprises a ringtone.

18. A method as defined in claim 1, wherein the first network device includes a local hard drive and wherein the second network device comprises a mobile device, and wherein the method further comprises providing the second network device with access to the local hard drive via the communication link such that the second network device can access the converted media content from the hard drive.

19. A computer program on computer readable medium comprising instructions to cause a computer to:
access media content in a first media format;
obtain configuration information regarding the second network device, at least a portion of the configuration information descriptive of at least one media format compatible with the second network device;
identify a second media format compatible with the second network device;
convert the media content from the first media format to the second media format to form a converted media content;
instruct a third network device to send a message to the second network device, the message configured to cause the second network device to establish a communication link with the first network device;
upon establishment of the communication link between the first and second network devices, transfer the converted media content in the second format to the second network device.

20. An information processing system comprised of an information processor configured to execute program instructions that cause the information processing system to implement one or more processes for distributing media content from a first network device to a second network device, the processes comprising:
accessing media content in a first media format;
obtaining configuration information regarding the second network device, at least a portion of the configuration information descriptive of at least one media format compatible with the second network device;
identifying a second media format compatible with the second network device;
converting the media content from the first media format to the second media format to form a converted media content;
instructing a third network device to send a message to the second network device, the message configured to cause the second network device to establish a communication link with the first network device;
upon establishment of the communication link between the first and second network devices, transferring the converted media content in the second format to the second network device.
